(19) United States
(12) Patent Application Publication
(10) Pub. No.: US 2008/0155754 A1
(43) Pub. Date: Jul. 3, 2008

(54) Craniosacral Therapeutic Apparatus

(75) Inventors: Roy Donald Desjarlais, Palm Beach Gardens, FL (US); Donald Charles Duncan, Palm Springs, FL (US)

Correspondence Address: DARBY & DARBY (formerly Sacco & Associates), P.O. BOX 770, CHURCH STREET STATION, NEW YORK, NY, 10008-0770, US

(73) Assignee: THE UPLEDGER INSTITUTE, INC., Palm Beach Gardens, FL (US)

(21) Appl. No.: 11/554,630

(22) Filed: Oct. 31, 2006

(51) Int. Cl. A47C 20/02; B68G 5/00

(52) U.S. Cl. 5/652

(57) ABSTRACT

An apparatus (10) for a craniosacral therapy technique is provided. The apparatus (10) is configured as a headrest for a human being to rest their head on. The apparatus (10) is comprised of a resilient monocoque structure having a sidewall made from a thermo-plastic elastomer. The apparatus (10) is comprised of a base portion (105), two semi-spherical shaped protuberances (120, 130) extending upward from the base portion (105), and a channel (125) formed between the two protuberances (120, 130). The adjacent protuberances (120, 130) put stabilizing bi-lateral pressure on the occipital region of the head to induce what is known as a “still point”. After a rest period of up to twenty minutes, the pressure on the occipital region is removed. The release of the apparatus (10) allows production of cerebrospinal fluids which then gently flushes these areas of tissue restrictions or adhesions thereby improving circulation and facilitating greater balance and function of the central nervous system.

### STATEMENT OF THE TECHNICAL FIELD

The invention relates to an apparatus for a craniosacral therapy technique. More particularly, this invention relates to a craniosacral therapeutic apparatus configured as a headrest wherein a pair of semi-spherical protuberances put bi-lateral stabilizing pressure on the occipital region of a human head for inducing a still point.

### BACKGROUND OF THE INVENTION

The craniosacral system consists of the membranes and cerebrospinal fluid that surround and protect the brain and spinal cord. The craniosacral system extends from the skull, face, and mouth, which make up the cranium, down to the sacrum, or tailbone area. Since the craniosacral system is a vital system that influences the development and performance of the brain and spinal cord, an imbalance or restriction in it could potentially cause any number of sensory, motor, or neurological difficulties. These problems could include chronic pain, eye difficulties, neurological disorders, learning disabilities and other health difficulties.

Craniosacral therapy is a gentle method of detection and correction that encourages natural healing mechanisms to dissipate the negative effects of stress on the central nervous system. Conventional techniques by practitioners of craniosacral therapy include using a light touch to evaluate the craniosacral system (CSS) to detect the potential restrictions and imbalances. Specific techniques are then used to release any restrictions and imbalances.

One technique craniosacral therapists use to release restrictions and imbalances in the craniosacral system is to gently induce an interruption in the natural rhythm in the flow of the cerebrospinal fluid. Such an interruption mimics naturally occurring resting of the cerebrospinal fluid known as a still point. The delicate interruption of the flow of the cerebrospinal fluid allows for a relaxation of the central nervous system, reorganization and rebalancing of the entire CSS. When the stillpoint ends and the cerebrospinal fluid begins to flow again, the movement of fluid gently “flushes” the system, facilitating the release of restrictions and adhesions in the membranous tissue.

Two phases in the craniosacral rhythm have been identified. In the flexion phase, the whole body externally rotates. The head actually widens, and the base of the sacrum moves posteriorly. In contrast, in the extension phase the body rotates internally and the head narrows. It has been theorized that the flexion phase of the rhythmical cycle is created when the input of cerebrospinal fluid into the semi-closed craniosacral system, formed by the dura mater membrane, exceeds the outflow. During the extension phase of the craniosacral rhythm, the input of cerebrospinal fluid is either shut off completely or is significantly less than the outflow. Thus, the flexion phase is one of filling, and the extension phase is one of emptying.

Craniosacral therapists can induce a still point by using manual techniques to resist either the flexion or extension phase. Generally, it is easier and more efficient to resist the filling (flexion) than emptying (extension). Such manual techniques include the therapist stabilizing the occipital region of the head. However, there are some drawbacks in using a therapist to induce a still point. One drawback is that a therapist isn't always available whenever a stillpoint is desired or needed.

There are devices known in the art for allowing a human being to self induce a still point. For example, in U.S. Pat. No. 5,933,890 to Codd, there is a therapeutic pillow for inducing a state of physiological relaxation. The pillow is formed from a substantially shaped sustaining material and comprises an upwardly facing concave supporting surface formed by four component surfaces which are separated by a cruciform shaped recess. However, such a pillow is expensive to manufacture and does not provide a construction which allows for a variable resiliency or stabilizing pressure applied to the occipital region.

Another example can be found in U.S. Pat. Nos. 6,238,413 and 6,773,449 issued to Wexler which show a mounting apparatus for applying pressure to the back of a human head having a harness for attaching the apparatus to the from portion of the head and a therapeutic pad attached to the harness. The therapeutic pad has a first and a second protrusion on an inner surface thereof, each adapted to contact an occiput at the back of the head. Such a device is cumbersome to put on the head and uncomfortable for the user to wear.

In view of the forgoing, there remains a need for an apparatus which a human being can self induce a still point by manually resisting the filling of the craniosacral system with cerebrospinal fluid. The apparatus must be easy to use, comfortable, and provide for a construction that can be easily modified to provide a variable resiliency and cushioning. The present invention fulfills this need by providing an apparatus configured as a head rest which puts stabilizing pressure on the occipital region of the head temporarily interrupting the flow of the cerebrospinal fluid.

### SUMMARY OF THE INVENTION

The invention concerns an apparatus for performing a craniosacral therapy technique. In one embodiment of the invention, the apparatus is configured as a headrest comprising a resilient monocoque structure having a sidewall made from a material. The resilient structure is formed from a base portion and at least two protuberances integrally formed with and extending upward from the base portion. There is a channel formed between the at least two protuberances and a bridge connecting the at least two protuberances together which partially defines the channel. Each of the at least two protuberances has a shoulder that tapers into the channel. The at least two protuberances are semi-spherical shaped and are symmetrical about the channel.

The sidewall includes a first sidewall opposed from a second sidewall and a third sidewall opposed from a fourth sidewall. The third sidewall joins the first sidewall to the second sidewall at a first end. The fourth sidewall joins the first sidewall to the second sidewall at a second end opposed to the first end. The first, second, third, and fourth sidewalls collectively define a bottom edge of the resilient structure. The first, second, third, and fourth sidewalls taper radially outward from a vertical axis of the body portion from a top of the at least two protuberances to the bottom edge. The sidewall is comprised of a thermo-plastic elastomer.

The sidewall of the resilient structure has an outer surface and an inner surface. The resilient structure has a hollow interior bounded at least partially by the inner surface. Each of the at least two protuberances are strengthened by a reinforcement structure. The reinforcement structure is disposed on an underside of the protuberance. The reinforcement structure is formed from a first plurality of reinforcement members interlaced with a second plurality of reinforcement members. The reinforcement structure is integrally formed with the protuberance.

In another embodiment of the invention, the apparatus includes a plate removably attached to the bottom edge of the resilient structure. The removable plate provides a foundation for the structure when the structure is placed on a surface. The plate is removably attached to the structure with a plurality of posts extending upwardly from and spaced apart on the periphery of the plate. The plurality of posts is received by a complementary plurality of sockets which are similarly spaced apart adjacent to the bottom edge of the base portion of the structure. The plurality of posts is grasped by the plurality of sockets in a frictional type fit. The removable plate improves the structural rigidity of the structure by preventing the bottom edges of the first, second, third and fourth sidewalls of the structure from deforming when pressure is applied onto the at least two protuberances. The removable plate includes a ridge on the upper surface which is spaced from the peripheral edge of the removable plate. The ridge defines a shelf on the periphery of the removable plate wherein the bottom edge of the base portion of the structure is seated.

### BRIEF DESCRIPTION OF THE DRAWINGS

Embodiments will be described with reference to the following drawing figures, in which like numerals represent like items throughout the figures, and in which:

FIG. 1 is a perspective view of one embodiment of a craniosacral therapy apparatus that is useful for understanding the invention.

FIG. 2 is a front view of the apparatus of FIG. 1.

FIG. 3 is a top view of the apparatus of FIG. 1.

FIG. 4 is a side view of the apparatus of FIG. 1.

FIG. 5 is a bottom perspective view of the apparatus of FIG. 1.

FIG. 6 is a front view of another embodiment of a craniosacral therapy.

FIG. 7 is an exploded front view of the apparatus of FIG. 6.

FIG. 8 is an exploded bottom perspective view of the apparatus of FIG. 6.

FIG. 9 is a side view of the apparatus of FIG. 1 showing the intended use thereof by a human being.

FIG. 10 is a rear view of the apparatus of FIG. 1 showing the intended use thereof by a human being.

### DETAILED DESCRIPTION OF THE PREFERRED EMBODIMENTS

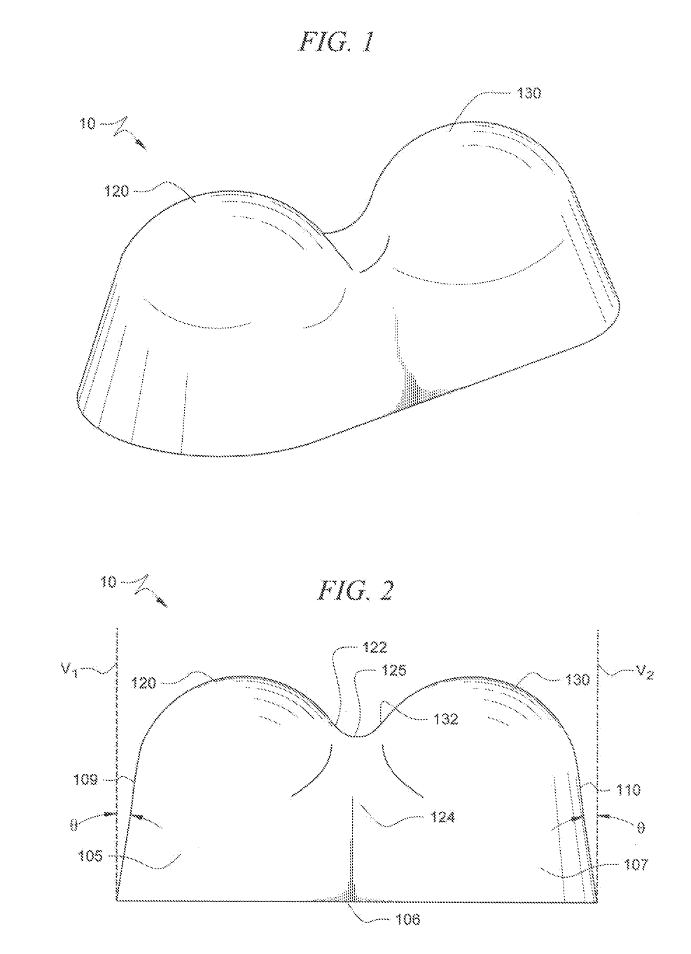

Referring now to FIG. 1, shown is a perspective view of one embodiment of a craniosacral therapeutic apparatus 10 that is useful for understanding the invention. The therapeutic apparatus 10 is configured as a headrest which a human being rests their head on. The apparatus has two protuberances 120, 130 for putting bi-lateral stabilizing pressure on the occipital region of the head. The pressure temporarily interrupts the flow of cerebrospinal fluid in the craniosacral system of a human being to induce an otherwise natural interruption of the flow of cerebrospinal fluid known as a still point.

The therapeutic apparatus 10 is a resilient structure made by injection molding a material to form a sidewall of a finite thickness. In one embodiment of the invention, the material is comprised of thermo-plastic elastomer (TPE). However, the selection of TPE is not limiting because there is known in the art a number of other materials that could be used that have the desired properties and are capable of being molded and shaped as shown. In one embodiment of the invention, the thickness of the TPE sidewall is approximately one-eighth of an inch. However, this selection of the thickness of the sidewall is not limiting as the thickness chosen could vary according to the resiliency desired for the apparatus 10 to take into account other factors such as the amount of pressure desired to be placed on the back of the human being's head by the protuberances 120, 130 and the weight of the human being's head.

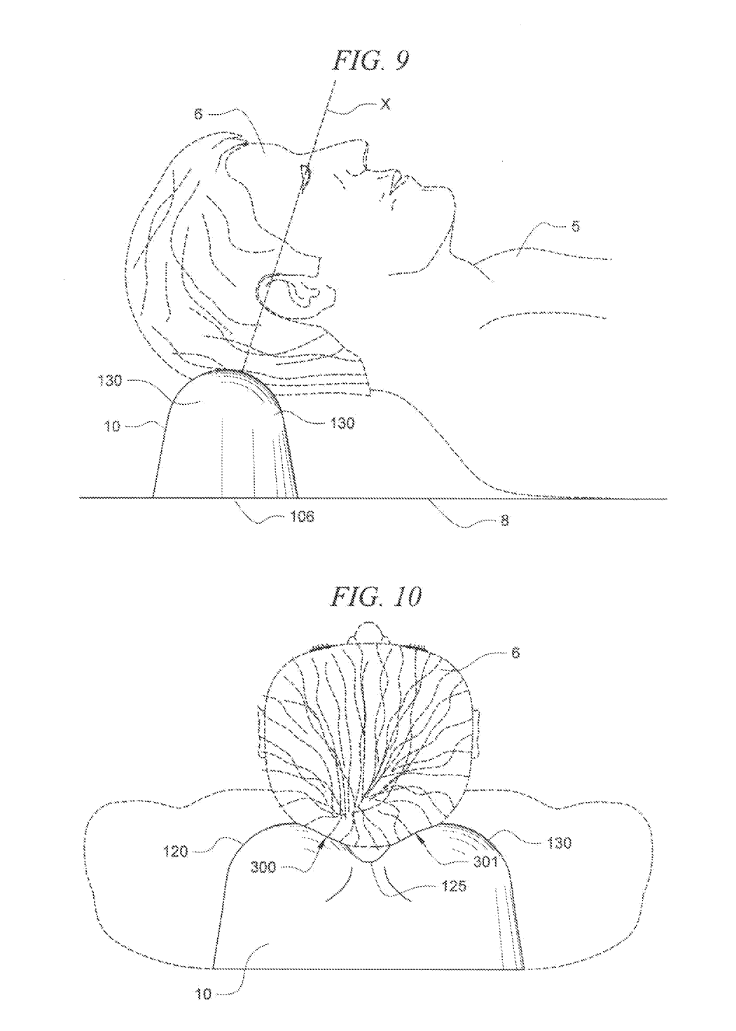

Referring now to FIGS. 2 to 4, the resilient structure of apparatus 10 includes a base portion 105 which serves as a base for the pair of protuberances 120, 130 which extend upwardly from the base portion 105. In one embodiment of the invention, the protuberances 120, 130 are semi-spherical in shape. However, the invention is not limited in this regard. The protuberances 120, 130 are for putting bi-lateral stabilizing pressure on the occipital region of the head (see FIGS. 9 and 10). The base portion 105 has a bottom edge 106 that extends around and forms the periphery of the therapeutic apparatus 10. The base portion 105 is approximately six inches in length and three and one-half inches in width at a point adjacent the bottom edge 106. The apparatus 10 is two and one-half inches in height from the bottom edge 106 to the top of the protuberances 120, 130. Still, the invention is not limited in this regard.

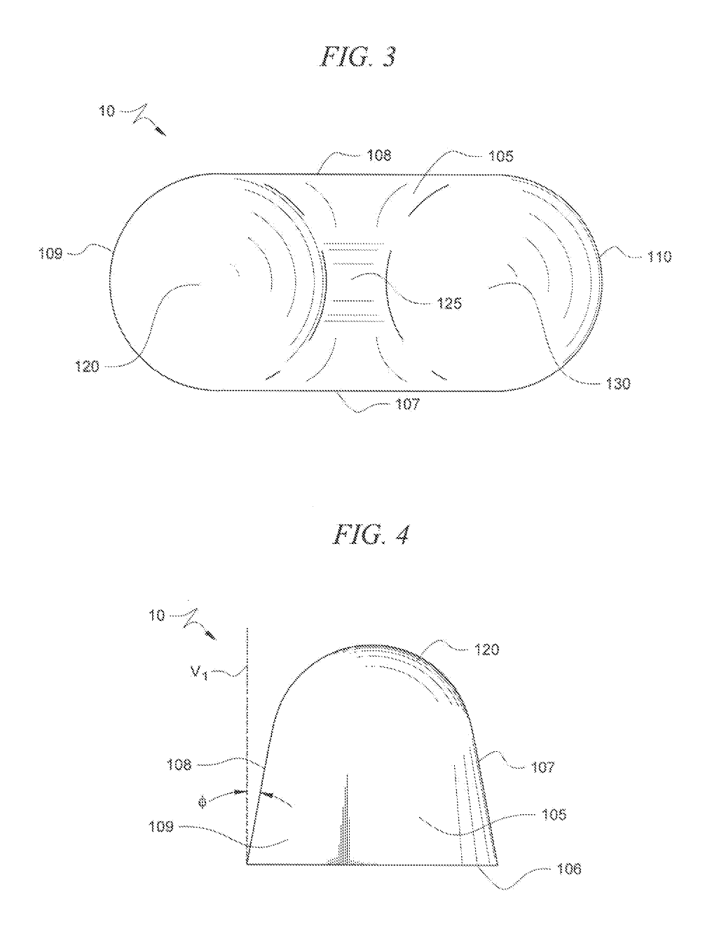

The base portion 105 is partially comprised of a bridge 124 that connects the adjacent protuberances 120, 130. The bridge 124 also partially forms a channel 125 between the protuberances 120, 130. There is a shoulder 122 between the protuberance 120 and channel 125. There is another shoulder 132 between protuberance 130 and the channel 125. The base portion 105 is comprised of a first sidewall 107 opposed from a second sidewall 108 (FIG. 4). The first sidewall 107 is connected to the second sidewall 108 by a third sidewall 109 at one end of base portion 105 and at an opposing end of base portion 105 by a fourth sidewall 110 (best seen in FIG. 3). The third sidewall 109 and fourth sidewall 110 are curved to meet the first sidewall 109 and second sidewall 110 at their respective ends. The third sidewall 109 tapers radially outward an angle Θ from the vertical axis V₁ from the top of projection 120 to the bottom edge 106. The fourth sidewall 110 tapers radially outward an angle Θ from the vertical axis V₂ from the top of protuberance 130 to the bottom edge 106. The first and second sidewalls 107, 108 taper radially outward at an angle φ from the vertical axes V₁, V₂ of base portion 105 from the top of protuberances 120, 130 to the bottom edge 106. In one embodiment of the invention, θ=10° and φ=10°. Still, the invention is not limited in this regard as θ and φ can be variable to select the desired strength and resiliency of the resilient structure. Collectively, the first sidewall 107, second sidewall 108, third sidewall 109, and fourth sidewall 110 form a unitary sidewall 111 that defines the resilient structure.

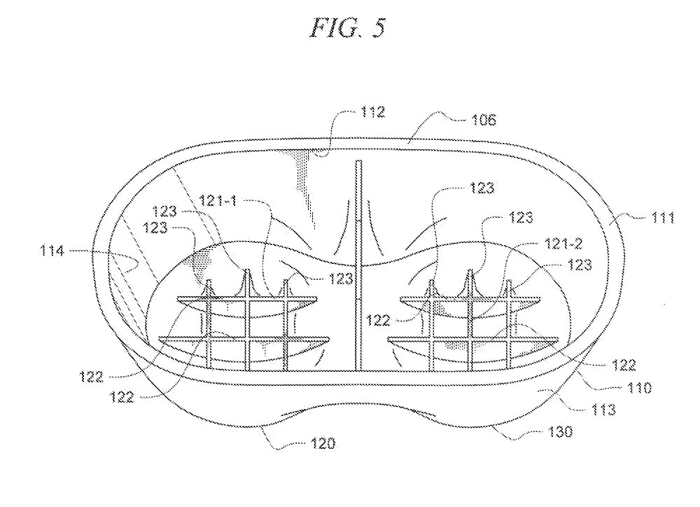

Referring now to FIG. 5, shown is an elevated bottom perspective view of the therapeutic apparatus 10. As discussed, the apparatus 10 is formed from a resilient monocoque structure having a unitary sidewall 111. The sidewall 111 has an inner surface 112 and an outer surface 113. The inner surface 112 at least partially defines a hollow interior 114. Both the hollow interior 114 and the unitary sidewall 111 the resilient structure is made from contribute to the required resiliency or cushioning that is critical to the apparatus 10 applying the proper amount of stabilizing pressure to the occipital region of the head. If there is too much resiliency, the apparatus 10 would be ineffective and no stillpoint would be induced. If there is not enough resiliency in the apparatus 10, the apparatus 10 would be so uncomfortable that nobody would want to use it.

There are reinforcement structures 121-1, 121-2 located on the underside of protuberances 120, 130. The reinforcement structures 121-1, 121-2 are integrally formed in the sidewall 111 partially forming protuberances 120, 130. The reinforcement structures 121-1, 121-2 serve to strengthen the protuberances 120, 130 and distribute the weight of a head placed on protuberances 120, 130 more uniformly to the adjacent first and second sidewalls 107, 108 (FIG. 4) and the respective third sidewall 109 (projection 120) and the fourth sidewall 110 (projection 130). Each of the reinforcement structures 121-1, 121-2 is comprised of a first plurality of reinforcement members 122 interlaced with a second plurality of reinforcement members 123. In one embodiment of the invention, the first plurality of reinforcement members 122 is perpendicular to the second plurality of reinforcement members 123. Still, the invention in not limited in this regard. The dimensions of the first plurality of reinforcement members 122 and second plurality of reinforcement members 123 including the height, length, and spacing therebetween are advantageously selected to provide a desired strengthening of protuberances 120, 130 while also contemplating a desired resiliency of protuberances 120, 130.

It should be understood that the apparatus 10 formed from the resilient monocoque structure having a unitary sidewall 111, a hollow interior 114, and reinforcement structures 121-1, 121-2 reduces the amount of material required to manufacture an otherwise solid structure. This results in lower overall manufacturing costs.

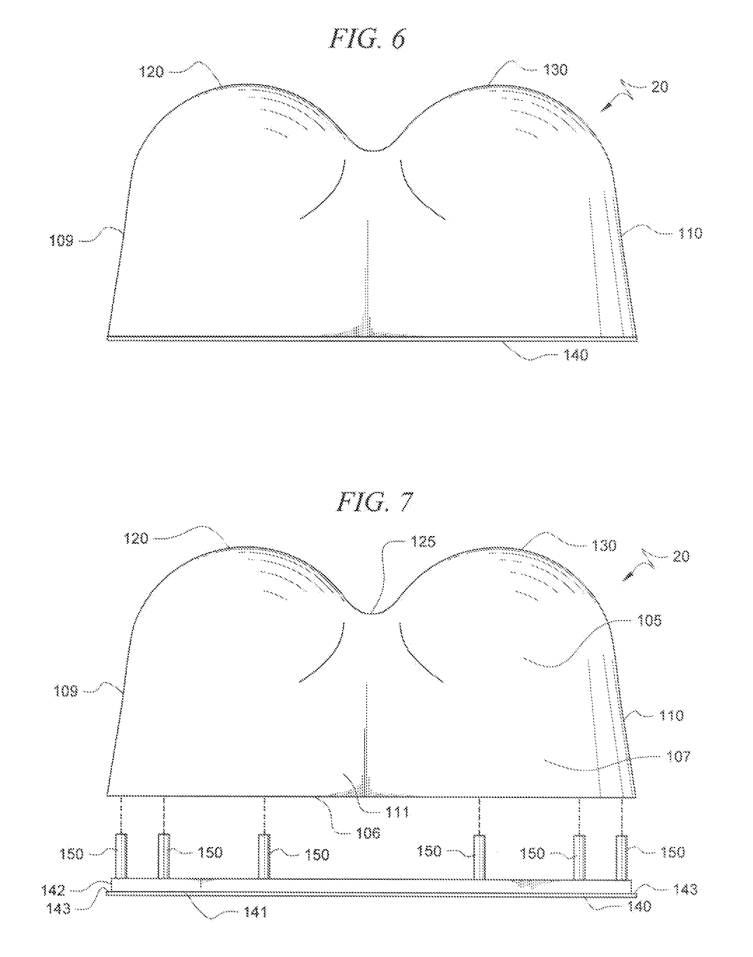

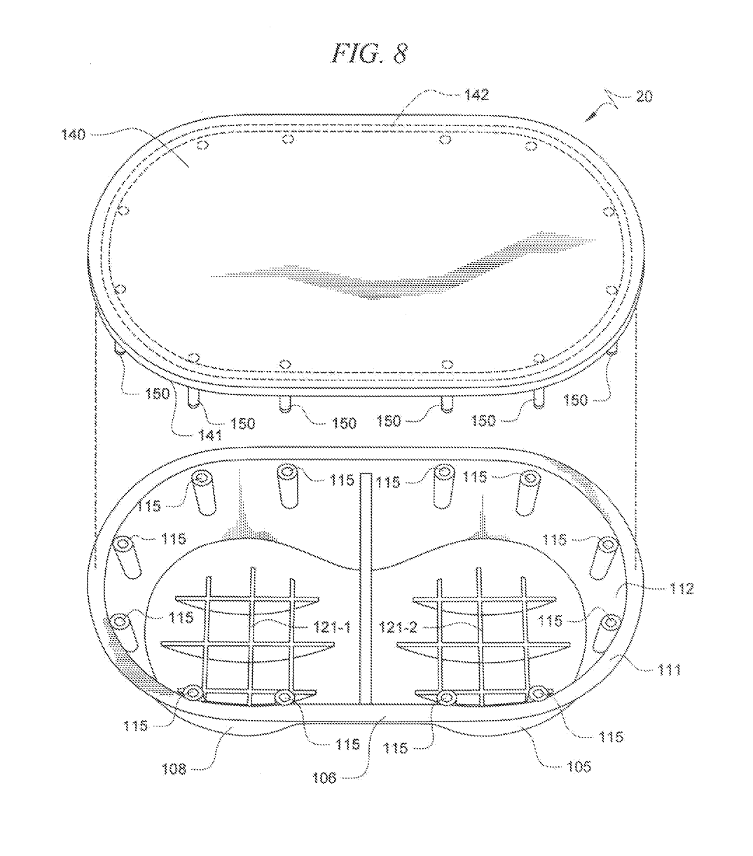

Referring now to FIGS. 6 through 8, shown is another embodiment of a craniosacral therapeutic apparatus 20 having a removable plate 140 for providing a foundation for a craniosacral therapeutic apparatus such as the craniosacral therapeutic apparatus 10 previously described in FIGS. 1 through 5. The apparatus 20 is identical to the apparatus 10 of FIGS. 1 through 5 including having two protuberances 120, 130, a base portion 105 formed from a unitary sidewall 111, and a channel 125 between the protuberances 120, 130. The base portion 105 is comprised of a first sidewall 107 opposed from a second sidewall 108 (not shown). The first sidewall 107 is connected to the second sidewall 108 (not shown) by a third sidewall 109 at one end of base portion 105 and at an opposing end of base portion 105 by a fourth sidewall 110. There are reinforcement structures 121-1, 121-2 located on the underside of protuberances 120, 130.

The removable plate 140 provides the apparatus 20 with improved structural rigidity by preventing the bottom edges of the first sidewall 107 and second sidewall 108 (not shown) from deforming when pressure is applied onto protuberances 120, 130. Similarly, the plate 140 prevents the bottom edges of the third sidewall 109 and the fourth sidewall 110 from deforming when pressure is put onto protuberances 120, 130. As a result, the removable plate 140 contributes to the overall resiliency of the apparatus 20. The removable plate 140 is attached to the bottom edge 106 of base portion 105 by a plurality of posts 150 that are located on and extend upwardly from the upper surface of plate 140 and are spaced around the periphery of the plate 140. The plurality of posts 150 are received in a plurality of complementary sockets 115 spaced around the periphery of the bottom edge 106 collectively defined by first, second, third and fourth sidewalls, 107, 108, 109, 110. The plurality of sockets 115 are located on the inner surface 112 of sidewall 111 adjacent the bottom edge 106. The plurality of posts 150 are gripped in sockets 115 in a frictional type fit. In the embodiment shown, there are twelve posts 150 and twelve sockets 115. However, the number of posts 150 and sockets 115 is not limiting as the number of posts 150 and sockets 115 could vary according to design requirements.

There is a ridge 142 (FIG. 7) located on the upper surface of plate 140 exterior of the plurality of posts 150 on the periphery of plate 140. There is a shelf 143 defined by the ridge 142 and the edge 141 of plate 140. The bottom edge 106 of the base portion 105 is seated onto the shelf 143 of plate 140. The ridge 142 also prevents the bottom edge 106 of base portion 105 from deforming inward when pressure is applied to protuberances 120, 130.

Referring now to FIGS. 9 and 10, shown is a side and rear view of the intended use of the therapeutic apparatus 10 of FIGS. 1 through 5. Alternatively, the therapeutic apparatus 20 of FIGS. 6 through 8 is used in the same fashion. In use, the therapeutic apparatus 10 is placed on a level surface 8. A human being 5 lies down on the level surface 8 and places their head 6 so that a portion of their head 6 is inserted into the channel 125 in between protuberances 120, 130. The channel 125 keeps the head 6 fixed when the head 6 is rested on the therapeutic apparatus 10. The head 6 is positioned on the therapeutic apparatus 10 such that the human being's eyes and ears on head 6 and the therapeutic apparatus 10 are aligned along line X. The protuberances 120, 130 put stabilizing pressure on the occipital region of the head identified by the arrows 300, 301. The human being 5 rests their head on the therapeutic apparatus 10 for a period up to twenty minutes. After the twenty minute period has expired, the human being 5 must remove their head 6 from the therapeutic apparatus 10. Sometime during the twenty minute period, the flow of cerebrospinal fluid in the craniosacral system has been interrupted to induce a still point. This procedure can be repeated several times a day for improving the flow of cerebrospinal fluid resulting in improved overall well-being.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that described herein while the same or similar results would be achieved. All such similar substitutes and modifications apparent to those skilled in the art are deemed to be within the spirit, scope and concept of the invention as defined.

We claim:

1. An apparatus for performing a craniosacral therapy technique, comprising:
a resilient monocoque structure having a sidewall, the structure comprising:
a base portion;
at least two protuberances integrally formed with and extending upward from said base portion, and
an open bottom in said base portion opening into a hollow interior.

2. The apparatus of claim 1, further comprising a channel formed between the at least two protuberances.

3. The apparatus of claim 2, wherein said at least two protuberances each have a shoulder that tapers into said channel.

4. The apparatus of claim 1, wherein said at least two protuberances are semi-spherical shaped.

5. The apparatus of claim 1, wherein said at least two protuberances are symmetrical about said channel.

6. The apparatus of claim 1, wherein said structure has an outer surface.

7. The apparatus of claim 1, wherein said structure has an inner surface.

8. The apparatus of claim 7, wherein said hollow interior is bounded at least partially by the inner surface.

9. The apparatus of claim 1, wherein each of said at least two protuberances are strengthened by a reinforcement structure.

10. The apparatus of claim 9, wherein said reinforcement structure is disposed on an underside of said at least two protuberances.

11. The apparatus of claim 9, wherein said reinforcement structure is formed from a first plurality of reinforcement members interlaced with a second plurality of reinforcement members.

12. The apparatus of claim 9, wherein said reinforcement structure is integrally formed with said protuberance.

13. The apparatus of claim 1, wherein said sidewall is comprised of a thermo-plastic elastomer.

14. The apparatus of claim 1, wherein said sidewall includes a first sidewall opposed from a second sidewall, a third sidewall opposed from a fourth sidewall, and said third sidewall and said fourth sidewall join said first sidewall to said second sidewall at a first end and join said first sidewall to said second sidewall at a second end opposed to said first end.

15. The apparatus of claim 14, wherein said first, second, third, and fourth sidewalls collectively define a bottom edge of said structure and taper radially outward from a vertical axis of said body portion from a top of said at least two protuberances to said bottom edge.

16. The apparatus of claim 1, further including a plate removably attached to said base portion.

17. A therapeutic headrest for applying stabilizing pressure to an occipital region of a human head, comprising:
a resilient monocoque structure having a sidewall and a hollow interior, comprising:
a base portion;
at least two protuberances integrally formed with said base portion and extending upward from said base portion;
a bridge connecting said at least two protuberances together and partially defining a channel separating said at least two protuberances; and
a plate removably attached to said base portion.

18. The therapeutic headrest of claim 17, wherein said at least two protuberances are semi-spherical shaped.

19. The therapeutic headrest of claim 17, wherein said hollow interior of said structure is bounded at least partially by an inner surface of said structure.

20. The therapeutic headrest of claim 17, wherein each of said at least two protuberances are strengthened by a reinforcement structure disposed on an underside of said at least two protuberances.

21. The therapeutic headrest of claim 17, wherein said reinforcement structure is formed from a first plurality of reinforcement members interlaced with a second plurality of reinforcement members.

22. The therapeutic headrest of claim 17, wherein said sidewalls include a first sidewall opposed from a second sidewall, a third sidewall opposed from a fourth sidewall, and said third sidewall and said fourth sidewall join said first sidewall to said second sidewall at a first end and join said first sidewall to said second sidewall at a second end opposed to said first end.

23. The therapeutic headrest of claim 22, wherein said first, second, third, and fourth sidewalls collectively define a bottom edge of said structure and taper radially outward from a vertical axis of said base from a top of said at least two protuberances to said bottom edge.

24. The therapeutic headrest of claim 23, wherein said plate includes a plurality of posts spaced around an outer periphery of said plate which are received in a complementary plurality of sockets formed adjacent to said bottom edge of said structure.

25. The therapeutic headrest of claim 17, wherein said sidewall is comprised of a thermo-plastic elastomer.
